(19) United States
(12) Patent Application Publication
(10) Pub. No.: US 2013/0099510 A1
(43) Pub. Date: Apr. 25, 2013

(54) LATCH ASSEMBLY

(71) Applicant: Ian J. Dow, Bloomfield, MI (US)

(72) Inventor: Ian J. Dow, Bloomfield, MI (US)

(21) Appl. No.: 13/276,788

(22) Filed: Oct. 19, 2011

(51) Int. Cl. E05C 3/16

(52) U.S. Cl. 292/226

(57) ABSTRACT

A latch having a fork bolt and a detent lever is provided. The detent lever being movable between an engaged position and a disengaged position. A first spring acts on the detent lever to urge the detent lever into the disengaged position or the engaged position.

### BACKGROUND OF THE INVENTION

The present invention relates to latch assemblies and, more specifically to a latch assembly having a hold open spring.

Certain passenger vehicles are equipped with a rear vehicle storage compartment, commonly known as a trunk. The trunk is closed by a deck lid that is hinged to the vehicle body and swings open to provide access to the storage compartment. Similarly, other vehicles are equipped with a lift gate that allows access to the rear of the vehicle through a gate that is hinged at or near the roof line of a vehicle and opens upward. Other vehicles have sliding doors that run horizontally on a track between an opened and closed position. Each of the deck lid, lift gate or sliding door can be thought of as panels that allow access to the interior of the vehicle compartment. Compartment latches, enable each of these types of panels to be secured and closed.

When it is desired to open these panels, it is known to use a remote unlatch mechanism that releases a detent lever from engagement with a fork bolt, allowing a striker pin to be removed from the catch (or throat) of the fork bolt. Advantageously, the deck lid, lift gate or sliding door will release from the striker pin and bias away from the striker due to shocks, springs, motors etc. incorporated in these panels. However, when the panel does not bias away, the remote unlatch mechanism that causes the detent lever to be released from engagement with the fork bolt is de-energized. As a result, the detent lever risks falling back into engagement with the fork bolt; and the panel cannot be opened. When the panel does not automatically bias open upon release of the detent lever from the fork bolt, it would be advantageous to maintain the detent lever in a released position until such time as the panel can be manually opened. Normally this is done with multiple additional parts, which adds complexity and cost to a latch.

### SUMMARY OF THE INVENTION

The above-discussed and other drawbacks and deficiencies of the prior art are overcome or alleviated by a latch including a fork bolt movable between an open position and closed position and a detent lever configured to cooperate with the fork bolt, is presented. The detent lever is movable between an engaged position and a disengaged position. In the engaged position the fork bolt is maintained in the closed position by the detent lever and in the disengaged position the fork bolt is allowed to rotate. The latch is in a latched position when the fork bolt is in the closed position and the detent lever is in the engaged position. The latch is in an unlatched position with the fork bolt in open position and the detent lever is in the disengaged position. The latch further includes a first spring acting on the detent lever with a first spring force to urge the detent lever rotationally towards the disengaged position. The first spring force acts to allow the fork bolt to rotate to the open position when latch is in the unlatched position. The latch still further includes a second spring acting on the fork bolt with a second spring force to urge the fork bolt rotationally towards the open position. The first and second spring forces act to maintain the fork bolt in the closed position when the latch is in the latched position.

A latch for cooperating with a striker pin is presented. The latch includes a housing with a fork bolt rotationally mounted to the housing. The fork bolt has a throat portion receptive to the striker pin and a first surface. The fork bolt is rotatable at least between an open position and closed position. In the open position the fork bolt is free to move away from or towards the striker pin and in the closed position the fork bolt is secured about the striker pin. A rotatable detent lever is also rotationally mounted to the housing. The detent lever has a second surface opposite the first surface of the fork bolt. The detent lever is rotatable at least between an engaged position and a disengaged position. In the engaged position the first and second surfaces are adjacent each other and in the disengaged position the first and second surfaces are away from each other. The latch further includes a first spring attached at one end thereof to the detent lever and at an other end thereof to the housing. The first spring urges the detent lever rotationally towards the disengaged position. The latch still further includes a second spring attached at one end thereof to the fork bolt and at an other end thereof to the housing. The second spring urges the fork bolt rotationally towards the open position.

The above-discussed and other features and advantages of the present invention will be appreciated and understood by those skilled in the art from the following detailed description and drawings.

### BRIEF DESCRIPTION OF THE DRAWINGS

Referring now to the drawings wherein like elements are numbered alike in the several FIGURES:

FIG. 1 is an illustration showing the latch in the unlatched position;

FIG. 2 is an illustration showing the transition position, wherein the latch is either latching or unlatching depending upon fork bolt rotation; and

FIG. 3 is an illustration showing the latch in the latched position.

### DETAILED DESCRIPTION

Exemplary embodiments of the present invention relate to an apparatus and method for providing a latch assembly. Furthermore, exemplary embodiments are directed to a latch assembly having a fork bolt movably secured thereto for movement between a latched position and an unlatched position. The latch assembly further comprising a detent lever capable of movement between an engaged position and a disengaged position, wherein the detent lever retains the fork bolt in the latched position when the detent lever is in the engaged position. The latch assembly further comprises an over center return spring that loads the detent lever in the engaged position until an actuator moves the detent lever to the disengaged position. The over center spring's load then holds the detent lever in the disengaged position until the action of the fork bolt returns the detent lever to the engaged position.

Certain passenger vehicles are equipped with a rear vehicle storage compartment, commonly known as a trunk. The trunk is closed by a deck lid that is hinged to the vehicle body and swings open to provide access to the storage compartment. Similarly, other vehicles are equipped with a lift gate that allows access to the rear of the vehicle through a gate that is hinged at or near the roof line of a vehicle and opens upward. Other vehicles have sliding doors that run horizontally on a track between an opened and closed position. Each of the deck lid, lift gate or sliding door can be thought of as panels that allow access to the interior of the vehicle compartment. Compartment latches, enable each of these types of panels to be secured and closed.

When it is desired to open these panels, it is known to use a remote unlatch mechanism that releases a detent lever from engagement with a fork bolt, allowing a striker pin to be removed from the catch (or throat) of the fork bolt. Advantageously, the deck lid, lift gate or sliding door will release from the striker pin and bias away from the striker pin due to shocks, springs, motors etc. incorporated in these panels. However, when the panel does not bias away, the remote unlatch mechanism that cause the detent lever to be released from engagement with the fork bolt and the panel cannot be opened. When the panel does not automatically bias open upon release of the detent lever from the fork bolt, it would be advantageous to maintain the detent lever in a disengaged position until such time as the panel can be manually opened. Normally this is done with multiple additional parts, which adds complexity and cost to a latch.

Various exemplary embodiments of the present invention allow a detent lever of a latch to stay in a disengaged position. This can be useful when a door or lid that is held closed by the latch is intended to be open, but does not act in the desired fashion due to a circumstance not associated with the latch.

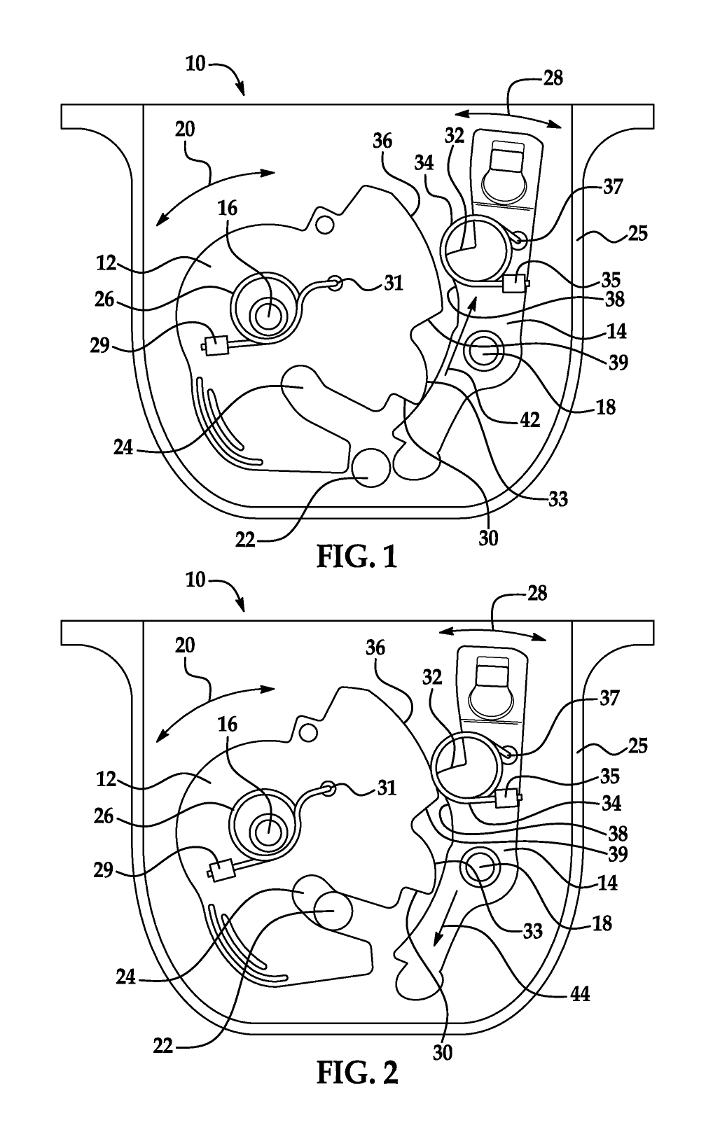

Referring now to the FIGS. embodiments of the invention will be described with reference to specific embodiments, without limiting the same, FIGS. 1-3 shows a latch or latch assembly designated 10, with one cover of the latch removed to facilitate illustrating the inner workings of the latch 10. In the exemplary embodiment shown latch 10 is a compartment latch. A compartment latch 10 of the type shown is useful for the rear compartment such as a trunk of a vehicle. The latch 10 can keep the trunk lid latched, can keep a lift gate vehicle latched or a sliding door vehicle closed, such as a van door. However, the invention is applicable to any environment where the features of the invention are desired. For example, the latch assembly can be secured to a hood, door, window, lift gate, trunk lid, etc. and the striker pin is secured to the vehicle body at an opening into which the hood, door, window, lift gate, trunk lid, etc. is received. Alternatively, the latch assembly can be attached to a vehicle body at an opening that a hood, door, window, lift gate, trunk lid, etc. is received such that the fork bolt is moved between the open position and the closed position when the hood, door, window, lift gate, trunk lid, etc. is opened and closed and the fork bolt engages the striker pin that is secured to the hood, door, window, lift gate, trunk lid, etc.

Referring now to the FIGs., the latch 10 is located on a first element, such as a trunk lid (not shown), and includes a fork bolt 12 and a detent lever 14 each being pivotally mounted. The fork bolt 12 being capable of rotation about a first stud 16, while detent lever 14 is capable of rotation about a second stud 18.

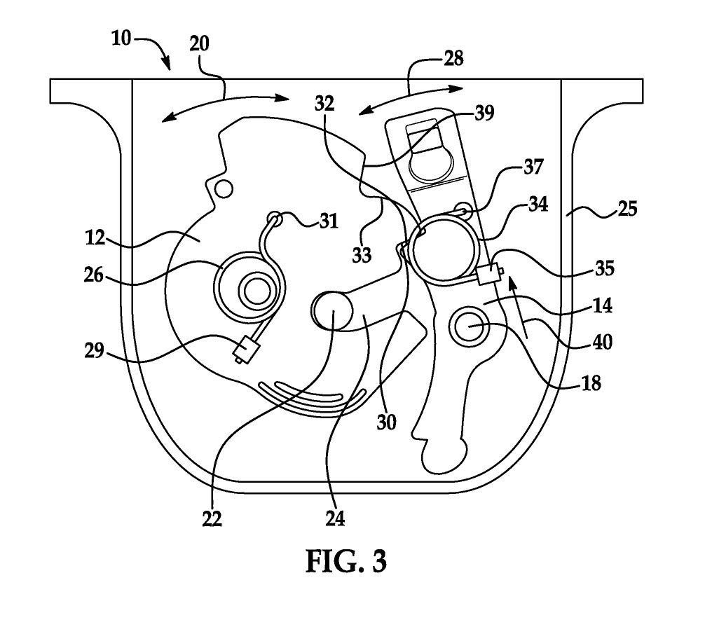

In accordance with the exemplary embodiment, the fork bolt 12 is capable of movement in the directions indicated by an arrow line 20 between an open position (shown in FIG. 3) where a striker pin 22 is engaged by a throat 24 of the fork bolt 12 and a closed position (shown in FIG. 1) where the striker pin 22 is free to be released from the throat 24 of the fork bolt 12. A housing 25 of the latch 10 also has a complimentary opening 27 for the receipt of the striker pin 22 therein when it is engaged by the fork bolt 12. The fork bolt 12 is biased by a second over center spring 26 in the open position. The spring 26 is attached at one end 29 to the housing at the other end 31 to the fork bolt 12. While spring 26 is described as an over center spring in this exemplary embodiment, other spring configurations that would bias the fork bolt 12 towards the open position may be employed without departing from the spirit and scope of the invention. The fork bolt 12 is formed from metal (e.g., steel), plastic, or any other suitable material.

The detent lever 14 is pivotally secured to the housing 25 for movement in the directions of an arrow line 28 between an engaged position (shown in FIG. 3) and the disengaged position (shown in FIG. 1). The latch 10 is in a latched position when the fork bolt 12 is retained in the closed position by the detent lever 14. The detent lever is in the engaged position when it is retaining the fork bolt 12. In the engaged position, a first shoulder surface 30 of the fork bolt 12 is engaged by a second shoulder surface 32 of the detent lever 14, wherein the fork bolt 12 is prevented from moving toward the open position from the closed position. A first over center spring 34 is provided for biasing the detent lever 14 in the direction of the engaged position, when in the latch 10 is in the latched position. The spring 34 is further provided for biasing the detent lever 14 in the direction of the disengaged position, when in the latch 10 is in the unlatched position. The spring 34 is attached at one end 35 to the housing at the other end 37 to the detent lever 14. While spring 34 is described as an over center spring in this exemplary embodiment, other spring configurations that would bias the detent lever 14 towards the engaged position when the latch 10 is in the latched position and towards the disengaged position when the latch 10 is in the unlatched position, may be employed without departing from the spirit and scope of the invention. The spring 34 biasing the detent lever 14 towards the engaged position when the latch 10 is in the latched position and towards the disengaged position when the latch 10 is in the unlatched position is an important feature of the invention. The detent level 14 is formed from metal (e.g., steel), plastic, or any other suitable material.

In accordance with exemplary embodiments of the present invention, the fork bolt 12 has a first arcuate surface 36 that slides along and is in contact with a cooperating second arcuate surface 38 of the detent lever 14. Thus engaging the fork bolt 12 with the detent lever 14 and retaining the fork bolt 12 in the closed position, where the striker pin 22 is secured in the throat 24 of the fork bolt 12. When the fork bolt 12 is in the closed position and engaged by the detent lever 14; the detent lever 14 is biased by the spring 34 into contact with the fork bolt 12 such that the fork bolt 12 cannot rotate into the open position unless the detent lever 14 is moved back to the disengaged position.

In order to move the detent lever 14 to the disengaged position a release mechanism (not shown) coupled to the detent lever 14 is configured to move the detent lever 14 from the engaged position to the disengaged position upon actuation of the release mechanism, as is well known.

In FIG. 1 the detent lever 14 is rotated clockwise towards the disengaged position. In this position, shoulder portion 32 is moved out of engagement with shoulder portion 30, allowing fork bolt 12 to rotate clockwise towards the open position. This rotation of the fork bolt 12 allows the striker pin 22 to slide out of the throat 24; thereafter the fork bolt 12 continues to rotate in the clockwise direction under bias from the spring 26 until the striker pin 22 is completely moved away from the latch 10.

Referring to FIGS. 1-3, the latch 10 is moved from the latched position in FIG. 3, through a transitional position in FIG. 2, to the unlatched position in FIG. 1, during unlatching of the latch 10. The detent lever 14 is maintained in the engaged position by a spring force of the spring 34 in the direction of arrow 40 (FIG. 3), which causes shoulder surface 30 of the fork bolt 12 to contact the shoulder surface 32 of the detent lever 14. During unlatching of the latch 10, rotation of the detent lever 14 is initiated in a clockwise rotation by action of the release mechanism. The release mechanism is set into action manually by an operator or by an automatic lock-unlock mechanism, such being well known. This action of the release mechanism rotates the detent lever 14 in a clockwise direction, which causes the shoulder surface 32 to push against the shoulder surface 30, and thereby slightly rotating the fork bolt 12 in a counter clockwise direction against rotational spring forces of the spring 26 until the shoulder surface 32 no longer contacts the shoulder surface 30. The fork bolt 12 will then rotate back. At this point the release mechanism no longer acts on the detent lever 14 and the detent lever 14 continues to rotate in response to the rotational spring forces of the spring 34 until the spring forces of the spring 34 no longer urge rotation of the detent lever 14, which is the point of rest for the detent lever 14, i.e., the disengaged position. This is the disengaged position discussed above. The detent lever 14 is maintained in the disengaged position by a spring force of the spring 34 in the direction of arrow 42 (FIG. 1). The fork bolt 12 continues to rotate in a clockwise direction movement from the closed position towards the open position under the rotational spring forces of the spring 26. The detent lever 14 is in the at rest or disengaged position, and is maintained there by the spring forces of the spring 34. The arcuate surface 36 of the fork bolt 12 engages the cooperating arcuate surface 38 of the detent lever 14 as the fork bolt 12 continues to rotate. The rotation of the fork bolt 12 also urges the throat 24 of the fork bolt 12 against the striker pin 22 (FIG. 2). The fork bolt 12 continues to rotate about the striker pin 22 to the open position, as the panel moves away from the compartment. At which point the fork bolt 12 is clear of the striker pin 22 (FIG. 1), and the panel can continue to move away from the compartment.

Referring again to FIGS. 1-3, the latch 10 is moved from the unlatched position in FIG. 1, through the transitional position in FIG. 2, to the latched position in FIG. 3, during latching of the latch 10. The detent lever 14 is maintained in the disengaged position by a spring force of the spring 34 in the direction of arrow 42 (FIG. 3), which is the point of rest for the detent lever 14. During latching of the latch 10, rotation of the fork bolt 12 is initiated in a counterclockwise direction when the striker pin 22 is engaged. More specifically, as the panel is moved towards the compartment the striker pin 22 is received in the throat 24 of the fork bolt 12. The striker pin 22 contacts the throat 24 urging the fork bolt 12 to rotate about the striker pin 22. The fork bolt 12 continues to rotate about the striker pin 22 to the closed position, as the panel is moved toward the compartment. As the fork bolt 12 continues to rotate the arcuate surface 36 of the fork bolt 12 engages the cooperating arcuate surface 38 of the detent lever 14. The resulting force causes clockwise rotation of the detent lever 14, thereby deflecting the detent lever 14 beyond the neutral position, i.e., the disengaged position. This deflection results in a spring force of spring 34 in the direction of arrow 44 forcing the arcuate surface 38 to slide along the arcuate surface 36, until the shoulder 32 and the shoulder 30 abut. At this point the fork bolt 12 secures the striker pin 22 (FIG. 1), and the latch 10 is in the latched position (FIG. 1).

While preferred embodiments have been shown and described, various modifications and substitutions may be made thereto without departing from the spirit and scope of the invention. Accordingly, it is to be understood that the present invention has been described by way of illustrations and not limitation.

What is claimed is:

We claim:

1. A latch comprising:
a fork bolt movable between an open position and closed position;
a detent lever configured to cooperate with the fork bolt, the detent lever movable between an engaged position and a disengaged position, in the engaged position the fork bolt is maintained in the closed position by the detent lever and in the disengaged position the fork bolt is allowed to rotate, wherein the latch is in a latched position when the fork bolt is in the closed position and the detent lever is in the engaged position and in an unlatched position with the fork bolt in open position and the detent lever is in the disengaged position;
a first spring acting on the detent lever with a first spring force to urge the detent lever rotationally towards the disengaged position, the first spring force acts to allow the fork bolt to rotate to the open position when latch is in the unlatched position; and
a second spring acting on the fork bolt with a second spring force to urge the fork bolt rotationally towards the open position, the first and second spring forces act to maintain the fork bolt in the closed position when the latch is in the latched position.

2. The latch of claim 1, wherein the first spring is a torsion spring.

3. The latch of claim 2, wherein the first spring has a center axis which is offset from an axis of rotation of the detent lever.

4. The latch of claim 1, wherein the second spring is a torsion spring.

5. The latch of claim 4, wherein the second spring has a center axis which is proximate an axis of rotation of the fork bolt.

6. The latch of claim 1, wherein the first and second springs are torsion springs.

7. The latch of claim 6, wherein the first spring has a center axis which is offset from an axis of rotation of the detent lever, and the second spring has a center axis which is proximate an axis of rotation of the fork bolt.

8. The latch of claim 1, wherein the fork bolt has a first arcuate surface and the detent lever has a second arcuate surface, the second arcuate surface configured to cooperate with first arcuate surface to urge the detent lever towards the engaged position as the fork bolt moves towards the closed position.

9. A latch for cooperating with a striker pin, the latch comprising:
a housing:
a fork bolt rotationally mounted to the housing, the fork bolt having a throat portion receptive to the striker pin, the fork bolt further having a first surface, the fork bolt being rotatable at least between an open position and closed position, in the open position the fork bolt is free to move away from or towards the striker pin and in the closed position the fork bolt is secured about the striker pin;
a rotatable detent lever rotationally mounted to the housing, the detent lever having a second surface opposite the first surface of the fork bolt, the detent lever being rotatable at least between an engaged position and a disengaged position, in the engaged position the first and second surfaces are adjacent each other and in the disengaged position the first and second surfaces are away from each other;
a first spring attached at one end thereof to the detent lever and at an other end thereof to the housing, the first spring urging the detent lever rotationally towards the disengaged position; and
a second spring attached at one end thereof to the fork bolt and at an other end thereof to the housing, the second spring urging the fork bolt rotationally towards the open position.

10. The latch of claim 9, wherein the first spring is a torsion spring.

11. The latch of claim 10, wherein the first spring has a center axis which is offset from an axis of rotation of the detent lever.

12. The latch of claim 9, wherein the second spring is a torsion spring.

13. The latch of claim 12, wherein the second spring has a center axis which is proximate an axis of rotation of the fork bolt.

14. The latch of claim 9, wherein the first and second springs are torsion springs.

15. The latch of claim 14, wherein the first spring has a center axis which is offset from an axis of rotation of the detent lever, and the second spring has a center axis which is proximate an axis of rotation of the fork bolt.

16. The latch of claim 9, wherein the fork bolt has a first arcuate surface and the detent lever has a second arcuate surface, the second arcuate surface configured to cooperate with first arcuate surface to urge the detent lever towards the engaged position as the fork bolt moves towards the closed position.
